(19) United States
(12) Patent Application Publication
(10) Pub. No.: US 2025/0063312 A1
(43) Pub. Date: Feb. 20, 2025

(54) VOICE CLASSIFICATION IN HEARING AID

(71) Applicant: Starkey Laboratories, Inc., Eden Prairie, MN (US)

(72) Inventors: Dagan Shtifman, Pardes-Hanna (IL); Liron Pollak, Ness Ziona (IL); Nitzan Bornstein, Tel Aviv (IL)

(21) Appl. No.: 18/797,361

(22) Filed: Aug. 7, 2024

Related U.S. Application Data
(60) Provisional application No. 63/519,910, filed on Aug. 16, 2023.

(51) Int. Cl. H04R 25/00; G10L 25/30

(52) U.S. Cl. CPC H04R 25/507; G10L 25/30; H04R 2225/41; H04R 2225/43

(57) ABSTRACT

A processing system may receive reference audio data representing one or more voices and may generate, using a first machine learning (ML) model, an embedding of the reference audio data. The processing system receives live audio data representing sound detected by one or more microphones of a hearing instrument and may generate an input spectrogram of the live audio data. The processing system may use a second ML model to generate a masked spectrogram based on the embedding and the input spectrogram. The masked spectrogram represents a version of the live audio data in which portions of the live audio data spoken in the voices represented by the reference audio data are enhanced. The processing system may cause one or more receivers of the hearing instrument to output sound based on the masked spectrogram.

This application claims the benefit of U.S. Provisional Patent Application No. 63/519,910, filed 16 Aug. 2023, the entire contents of which is incorporated herein by reference.

### TECHNICAL FIELD

This disclosure relates to hearing instruments.

### BACKGROUND

Hearing instruments are devices designed to be worn on, in, or near one or more of a user's ears. Common types of hearing instruments include hearing assistance devices (e.g., “hearing aids”), earbuds, headphones, hearables, cochlear implants, and so on. In some examples, a hearing instrument may be implanted or integrated into a user. Some hearing instruments include additional features beyond just environmental sound-amplification. For example, some modern hearing instruments include advanced audio processing for improved functionality, controlling and programming the hearing instruments, wireless communication with external devices including other hearing instruments (e.g., for streaming media), and so on.

### SUMMARY

This disclosure describes techniques for enhancing voices of specific people or types of people in live audio by a hearing instrument. A processing system may receive live audio data representing sound detected by one or more microphones of the hearing instrument. The processing system may generate, using one or more machine learning models, a modified version of the live audio data in which the voices of specific people are enhanced. The processing system may utilize reference audio data obtained by the ear-wearable device to train the one or more machine learning models to generate masked spectrograms of the live audio data.

As described herein, a processing system may receive reference audio data representing one or more voices. For example, the reference audio data may be an audio clip of the voice of a friend or family member. The processing system may utilize a machine learning model, such as a deep neural network, to generate an embedding of the reference audio data. Additionally, the processing system may receive live audio data representing sound detected by one or more microphones of a hearing instrument. The processing system may generate a masked spectrogram representative of a version of the live audio data in which portions of the live audio spoken in the voices represented by the reference audio data are enhanced. The processing system may generate the masked spectrogram where the portions of the live audio data associated with one or more voices is enhanced in one or more ways such as increasing the volume of the one or more voices relative to volume of the rest of the sound output by the hearing instrument and shifting the frequencies associated with the one or more voices to lower frequencies to compensate for hearing loss of higher frequencies.

In an example, this disclosure describes a method comprising: receiving, by a processing system, reference audio data representing one or more voices; generating, by the processing system and using a first machine learning (ML) model, an embedding of the reference audio data; receiving, by the processing system, live audio data representing sound detected by one or more microphones of one or more hearing instruments; generating, by the processing system, an input spectrogram of the live audio data; using, by the processing system, a second ML model to generate a masked spectrogram based on the embedding and the input spectrogram, wherein the masked spectrogram represents a version of the live audio data in which portions of the live audio data spoken in the voices represented by the reference audio data are enhanced; and causing, by the processing system, one or more receivers of the one or more hearing instruments to output sound based on the masked spectrogram.

In another example, this disclosure describes a hearing instrument comprising: a memory; and one or more programmable processors, configured to: receive reference audio data representing one or more voices; generate, using a first machine learning (ML) model, an embedding of the reference audio data; receive live audio data representing sound detected by one or more microphones of the hearing instrument; generate an input spectrogram of the live audio data; use a second ML model to generate a masked spectrogram based on the embedding and the input spectrogram, wherein the masked spectrogram represents a version of the live audio data in which portions of the live audio data spoken in the voices represented by the reference audio data are enhanced; and cause one or more receivers of the one or more hearing instruments to output sound based on the masked spectrogram.

In another example, this disclosure describes a non-transitory computer-readable medium, configured to cause one or more processors to: receive reference audio data representing one or more voices; generate, using a first machine learning (ML) model, an embedding of the reference audio data; receive live audio data representing sound detected by one or more microphones of one or more hearing instruments; generate an input spectrogram of the live audio data; and use a second ML model to generate a masked spectrogram based on the embedding and the input spectrogram, wherein the masked spectrogram represents a version of the live audio data in which portions of the live audio data spoken in the voices represented by the reference audio data are enhanced; and cause one or more receivers of the one or more hearing instruments to output sound based on the masked spectrogram.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF DRAWINGS

FIG. 1 is a conceptual diagram illustrating an example system that includes one or more hearing instruments, in accordance with one or more techniques of this disclosure.

FIG. 2 is a block diagram illustrating example components of a hearing instrument, in accordance with one or more techniques of this disclosure.

FIG. 3 is a block diagram illustrating example components of a computing system, in accordance with one or more techniques of this disclosure.

FIG. 4 is a flowchart illustrating an example operation in accordance with one or more techniques described in this disclosure.

FIG. 5 is a flowchart illustrating an example operation in accordance with one or more techniques described in this disclosure.

### DETAILED DESCRIPTION

In many cases, it can be difficult for users of hearing instruments to hear particular voices because the users have hearing loss of particular frequency ranges (e.g., a user with hearing loss of higher frequencies may find it difficult to understand the voices of children). In addition, it can be difficult for users of hearing instruments to hear particular voices in noisy environments (e.g., a loud restaurant with multiple people talking simultaneously). The ability of hearing instruments to generate enhanced audio of voices and allows for users to more clearly hear particular voices. In addition, the ability of hearing instruments to enhance particular voices gives users control of which voices they want to hear instead of exclusively enhancing voices in general. The hearing instruments also enable users to select types of voices to enhance, such as voices associated with children or the elderly.

This disclosure describes techniques for enhancing voices of specific people or types of people in live audio by a hearing instrument. The hearing instrument may generate modified audio of live audio in which the voices of specific people are enhanced.

A hearing instrument may utilize a first machine learning (ML) model to generate an embedding of an individual's voice from reference audio. For example, a processing system may receive reference audio data representing the voice of an individual. The hearing instrument may generate an embedding of the reference audio data for use as input to a second ML model. The processing system may receive live audio data that represents sound detected by one or more microphones of the hearing instrument and generate an input spectrogram of the live audio data. The processing system may use the second ML model to generate a masked spectrogram based on the embedding and the input spectrogram. The masked spectrogram represents a version of the live audio data in which portions of the live audio data spoken in the voices represented by the reference audio data are enhanced. One or more receivers of the hearing instrument may output sound based on enhanced audio data. For instance, the processing system may convert the masked spectrogram into the enhanced audio data, and the one or more receivers may output the sound based on the enhanced audio data. Thus, the one or more receivers of the hearing instrument may output sound based on the masked spectrogram.

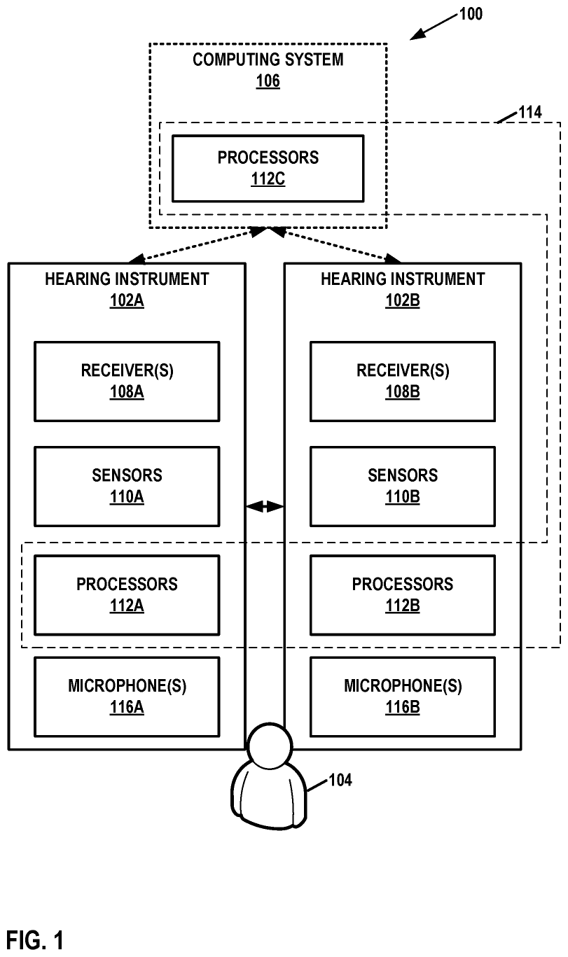

FIG. 1 is a conceptual diagram illustrating an example system 100 that includes hearing instruments 102A, 102B, in accordance with one or more techniques of this disclosure. This disclosure may refer to hearing instruments 102A and 102B collectively, as “hearing instruments 102.” A user 104 may wear hearing instruments 102. In some instances, user 104 may wear a single hearing instrument. In other instances, user 104 may wear two hearing instruments, with one hearing instrument for each ear of user 104.

Hearing instruments 102 may include one or more of various types of devices that are configured to provide auditory stimuli to user 104 and that are designed for wear and/or implantation at, on, near, or in relation to the physiological function of an ear of user 104. Hearing instruments 102 may be worn, at least partially, in the ear canal or concha. One or more of hearing instruments 102 may include behind the ear (BTE) components that are worn behind the ears of user 104. In some examples, hearing instruments 102 include devices that are at least partially implanted into or integrated with the skull of user 104. In some examples, one or more of hearing instruments 102 provides auditory stimuli to user 104 via a bone conduction pathway.

In any of the examples of this disclosure, each of hearing instruments 102 may include a hearing assistance device. Hearing assistance devices include devices that help user 104 hear sounds in the environment of user 104. Example types of hearing assistance devices may include hearing aid devices, Personal Sound Amplification Products (PSAPs), cochlear implant systems (which may include cochlear implant magnets, cochlear implant transducers, and cochlear implant processors), bone-anchored or osseointegrated hearing aids, and so on. In some examples, hearing instruments 102 are over-the-counter, direct-to-consumer, or prescription devices. Furthermore, in some examples, hearing instruments 102 include devices that provide auditory stimuli to user 104 that correspond to artificial sounds or sounds that are not naturally in the environment of user 104, such as recorded music, computer-generated sounds, or other types of sounds. For instance, hearing instruments 102 may include so-called “hearables,” earbuds, earphones, or other types of devices that are worn on or near the ears of user 104. Some types of hearing instruments provide auditory stimuli to user 104 corresponding to sounds from the user's environment and also artificial sounds. In some examples, hearing instruments 102 may include cochlear implants or brainstem implants. In some examples, hearing instruments 102 may use a bone conduction pathway to provide auditory stimulation. In some examples, one or more of hearing instruments 102 includes a housing or shell that is designed to be worn in the ear for both aesthetic and functional reasons and encloses the electronic components of the hearing instrument. Such hearing instruments may be referred to as in-the-ear (ITE), in-the-canal (ITC), completely-in-the-canal (CIC), or invisible-in-the-canal (IIC) devices. In some examples, one or more of hearing instruments 102 may be behind-the-ear (BTE) devices, which include a housing worn behind the ear that contains all of the electronic components of the hearing instrument, including the receiver (e.g., a speaker). The receiver conducts sound to an earbud inside the ear via an audio tube. In some examples, one or more of hearing instruments 102 are receiver-in-canal (RIC) hearing-assistance devices, which include housings worn behind the ears that contains electronic components and housings worn in the ear canals that contains receivers.

Hearing instruments 102 may implement a variety of features that help user 104 hear better. For example, hearing instruments 102 may amplify the intensity of incoming sound, amplify the intensity of certain frequencies of the incoming sound, translate or compress frequencies of the incoming sound, receive wireless audio transmissions from hearing assistive listening systems and hearing aid accessories (e.g., remote microphones, media streaming devices, and the like), and/or perform other functions to improve the hearing of user 104. In some examples, hearing instruments 102 implement a directional processing mode in which hearing instruments 102 selectively amplify sound originating from a particular direction (e.g., to the front of user 104) while potentially fully or partially canceling sound originating from other directions. In other words, a directional processing mode may selectively attenuate off-axis unwanted sounds. The directional processing mode may help user 104 understand conversations occurring in crowds or other noisy environments. In some examples, hearing instruments 102 use beamforming or directional processing cues to implement or augment directional processing modes.

In some examples, hearing instruments 102 reduce noise by canceling out or attenuating certain frequencies. Furthermore, in some examples, hearing instruments 102 may help user 104 enjoy audio media, such as music or sound components of visual media, by outputting sound based on audio data wirelessly transmitted to hearing instruments 102.

Hearing instruments 102 may be configured to communicate with each other. For instance, in any of the examples of this disclosure, hearing instruments 102 may communicate with each other using one or more wireless communication technologies. Example types of wireless communication technology include Near-Field Magnetic Induction (NFMI) technology, 900 MHz technology, BLUETOOTH™ technology, WI-FI™ technology, audible sound signals, ultrasonic communication technology, infrared communication technology, inductive communication technology, or other types of communication that do not rely on wires to transmit signals between devices. In some examples, hearing instruments 102 use a 2.4 GHz frequency band for wireless communication. In examples of this disclosure, hearing instruments 102 may communicate with each other via non-wireless communication links, such as via one or more cables, direct electrical contacts, and so on.

As shown in the example of FIG. 1, system 100 may also include a computing system 106. In other examples, system 100 does not include computing system 106. Computing system 106 includes one or more computing devices, each of which may include one or more processors. For instance, computing system 106 may include one or more mobile devices (e.g., smartphones, tablet computers, etc.), server devices, personal computer devices, handheld devices, wireless access points, smart speaker devices, smart televisions, medical alarm devices, smart key fobs, smartwatches, motion or presence sensor devices, smart displays, screen-enhanced smart speakers, wireless routers, wireless communication hubs, prosthetic devices, mobility devices, special-purpose devices, accessory devices, and/or other types of devices. Accessory devices may include devices that are configured specifically for use with hearing instruments 102. Example types of accessory devices may include charging cases for hearing instruments 102, storage cases for hearing instruments 102, media streamer devices, phone streamer devices, external microphone devices, external telecoil devices, remote controls for hearing instruments 102, and other types of devices specifically designed for use with hearing instruments 102.

Actions described in this disclosure as being performed by computing system 106 may be performed by one or more of the computing devices of computing system 106. One or more of hearing instruments 102 may communicate with computing system 106 using wireless or non-wireless communication links. For instance, hearing instruments 102 may communicate with computing system 106 using any of the example types of communication technologies described elsewhere in this disclosure.

In the example of FIG. 1, hearing instrument 102A includes receiver(s) 108A, sensors 110A, a set of one or more processors 112A, and microphone(s) 116A. This disclosure may refer to receiver(s) 108A and receiver(s) 108B collectively as “receivers 108.” This disclosure may refer to microphone(s) 116A and microphones 116B collectively as “microphones 116.” Computing system 106 includes a set of one or more processors 112C. Processors 112C may be distributed among one or more devices of computing system 106. This disclosure may refer to processors 112A, 112B, and 112C collectively as “processors 112.” Processors 112 may be implemented in circuitry and may include microprocessors, application-specific integrated circuits, digital signal processors, artificial intelligence (AI) accelerators, or other types of circuits.

As noted above, hearing instruments 102A, 102B, and computing system 106 may be configured to communicate with one another. Accordingly, processors 112 may be configured to operate together as a processing system 114. Thus, discussion in this disclosure of actions performed by processing system 114 may be performed by one or more processors in one or more of hearing instrument 102A, hearing instrument 102B, or computing system 106, either separately or in coordination. Moreover, it should be appreciated that, in some examples, processing system 114 does not include each of processors 112A, 112B, or 112C. For instance, processing system 114 may be limited to processors 112A and not processors 112B or 112C.

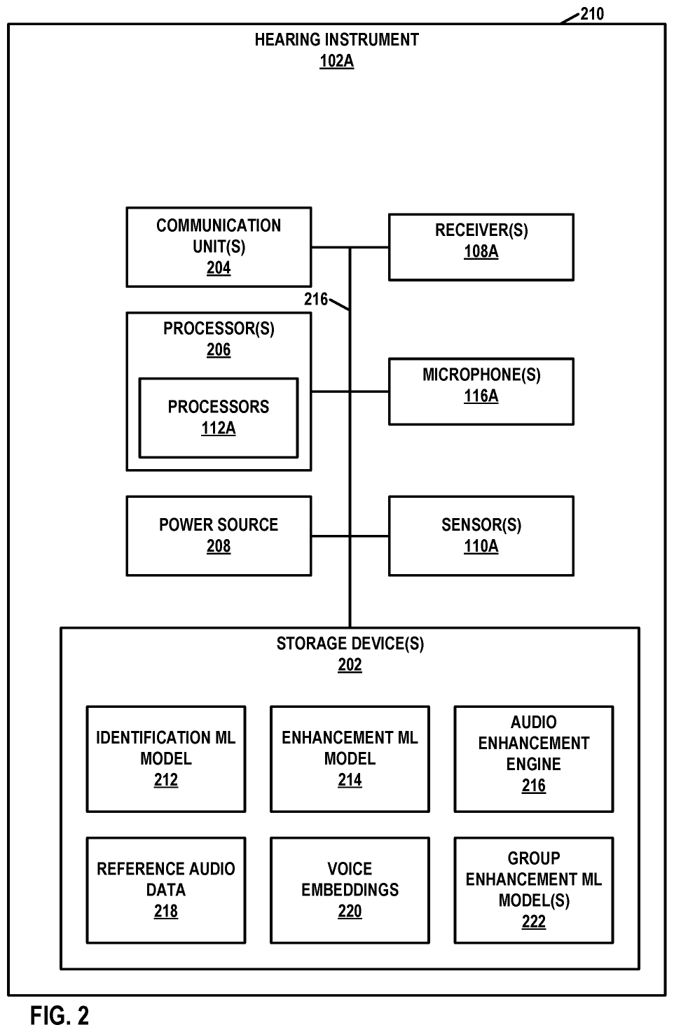

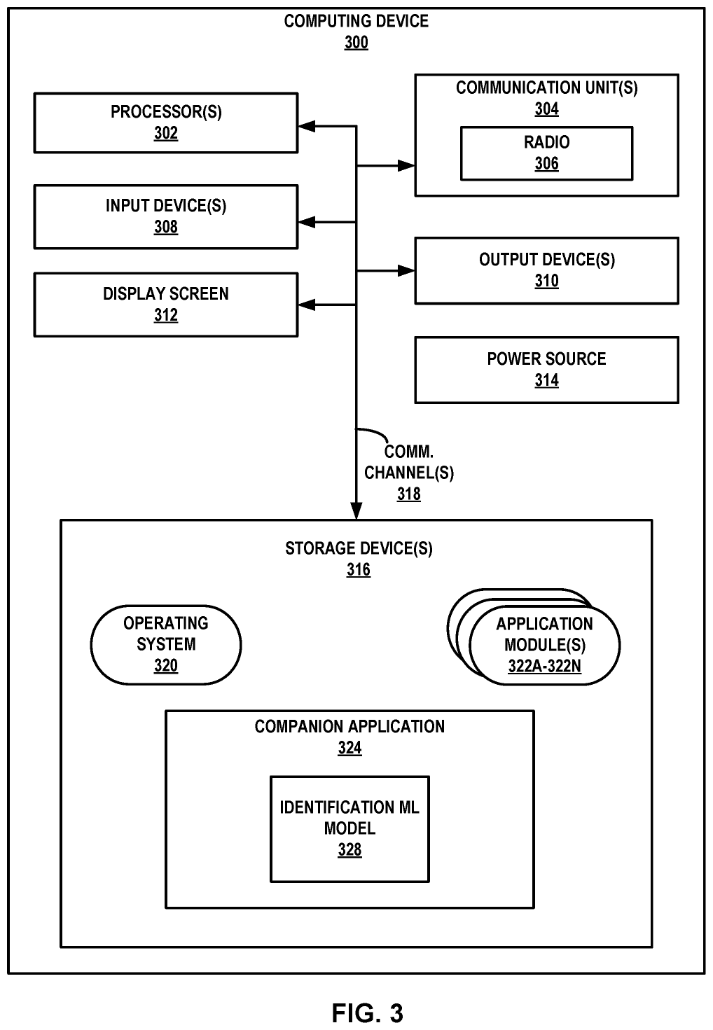

It will be appreciated that hearing instruments 102 and computing system 106 may include components in addition to those shown in the example of FIG. 1, e.g., as shown in the examples of FIG. 2 and FIG. 3. For instance, each of hearing instruments 102 may include one or more additional microphones configured to detect sound in an environment of user 104. The additional microphones may include omnidirectional microphones, directional microphones, own-voice detection sensors, or other types of microphones.

Processing system 114 may obtain reference audio data of one or more individuals for use in enhancing the audio of the individuals' voices. In some examples, processing system 114 may cause computing system 106 or hearing instruments 102 to request that a particular individual recite a spoken phrase to capture reference audio data of that particular individual's voice. Processing system 114 may process the reference audio data through a ML model to generate an embedding of the reference audio data. In some examples where processors 112C of computing system 106 generate the embedding, computing system 106 may provide the embedding to hearing instruments 102.

Hearing instruments 102 may receive live audio data regarding the audio detected by microphone(s) 116 and may process the live audio data to generate enhanced audio. Hearing instruments 102, responsive to receiving the live audio data, may generate an input spectrogram of the live audio data. Hearing instruments 102 may use a sparse fast Fourier transform (SFFT) to generate the input spectrogram. Hearing instruments 102 may process the input spectrogram to generate a version of the live audio data with one or more voices enhanced.

Hearing instruments 102 may generate a masked spectrogram based on an embedding and an input spectrogram, where the masked spectrogram represents a version of the live audio data in which portions of the live audio data spoken in the voice represented by the reference audio data are enhanced. Hearing instruments 102 may utilize a second ML model to generate the masked spectrogram based on the embedding and the input spectrogram. Hearing instrument 102 may perform an inverse SFFT on the masked spectrogram to generate enhanced audio data. The enhanced audio data is a version of the live audio data in which the voices represented by the reference audio data are enhanced.

Hearing instruments 102 may cause receivers 108 to output sound based on the masked spectrogram. For instance, hearing instruments 102 may cause receivers 108 to output sound based on the enhanced audio data, which is generated from the masked spectrogram. Receivers 108 may output sound where the voices of the reference audio data are enhanced in one or more ways (e.g., increased volume, shifting of the audio associated with the one or more voices to a lower frequency range, etc.).

FIG. 2 is a block diagram illustrating example components of hearing instrument 102A, in accordance with one or more aspects of this disclosure. Hearing instrument 102B may include the same or similar components of hearing instrument 102A shown in the example of FIG. 2. Thus, the discussion of FIG. 2 may apply with respect to hearing instrument 102B. In the example of FIG. 2, hearing instrument 102A includes one or more storage devices 202, one or more communication units 204, receivers 108, one or more processors 206, microphones 116A, sensors 110, a power source 208, and one or more communication channels 216. Communication channels 216 provide communication between storage devices 202, communication units 204, receivers 108A, processors 206, microphone(s) 114A, and sensors 110A. Storage devices 202, communication units 204, processors 206, receivers 108A, sensors 110A, and microphones 116A may draw electrical power from power source 208.

In the example of FIG. 2, each of storage devices 202, communication units 204, processors 206, receivers 108A, sensors 110A, microphones 116A, and power source 208 may be contained within a single housing 210. For instance, in examples where hearing instrument 102A is a BTE device, storage devices 202, communication units 204, processors 206, receivers 108A, sensors 110A, microphones 116A, and power source 208 may be contained within a behind-the-ear housing. In examples where hearing instrument 102A is an ITE, ITC, CIC, or IIC device, each of storage devices 202, communication units 204, processors 206, receivers 108A, sensors 110A, microphones 116A, and power source 208 may be contained within an in-ear housing. However, in other examples of this disclosure, storage devices 202, communication units 204, processors 206, receivers 108A, sensors 110A, microphones 116A, and power source 208 are distributed among two or more housings. For instance, in an example where hearing instrument 102A is a RIC device, receivers 108A, one or more of microphones 116A, and one or more of sensors 110A may be included in an in-ear housing separate from a behind-the-ear housing that contains the remaining components of hearing instrument 102A. In such examples, a RIC cable may connect the two housings.

Storage device(s) 202 may store data. Storage device(s) 202 may include volatile memory and may therefore not retain stored contents if powered off. Examples of volatile memories may include random access memories (RAM), dynamic random access memories (DRAM), static random access memories (SRAM), and other forms of volatile memories known in the art. Storage device(s) 202 may include non-volatile memory for long-term storage of information and may retain information after power on/off cycles. Examples of non-volatile memory may include flash memories or forms of electrically programmable memories (EPROM) or electrically erasable and programmable (EEPROM) memories.

Communication unit(s) 204 may enable hearing instrument 102A to send data to and receive data from one or more other devices, such as a device of computing system 106 (FIG. 1), another hearing instrument (e.g., hearing instrument 102B), an accessory device, a mobile device, or other types of devices. Communication unit(s) 204 may enable hearing instrument 102A to use wireless or non-wireless communication technologies. For instance, communication units 204 enable hearing instrument 102A to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, or another wireless communication technology. In some examples, communication units 204 may enable hearing instrument 102A to communicate using a cable-based technology, such as a Universal Serial Bus (USB) technology.

Receiver 108A includes one or more speakers for generating audible sound. In the example of FIG. 2, receiver 108A includes a speaker. The speakers of receiver 108A may generate sounds that include a range of frequencies. In some examples, the speakers of receiver 108A includes “woofers” and/or “tweeters” that provide additional frequency range.

Processors 206 include processing circuits configured to perform various processing activities. Processors 206 may process signals generated by microphones 116A to enhance, amplify, or cancel-out particular channels within the incoming sound. Processors 206 may then cause receiver 108A to generate sound based on the processed signals. In some examples, processors 206 include one or more digital signal processors (DSPs). In some examples, processors 206 may cause communication units 204 to transmit one or more of various types of data. For example, processors 206 may cause communication units 204 to transmit data to computing system 106. Furthermore, communication units 204 may receive audio data from computing system 106 and processors 206 may cause receivers 108A to output sound based on the audio data. In the example of FIG. 2, processors 206 include processors 112A (FIG. 1).

Microphones 116A detect incoming sound and generate one or more electrical signals (e.g., an analog or digital electrical signal) representing the incoming sound. In some examples, microphones 116A include directional and/or omnidirectional microphones.

Storage devices 202 may include an identification ML model 212, an enhancement ML model 214, an audio enhancement engine 216, reference audio data 218, voice embeddings 220, group enhancement ML models 222. Audio enhancement engine 216 may comprise instructions executable by processors 206. Actions described in this disclosure as being performed by audio enhancement engine 216 may be performed by processors 206 when processors 206 execute instructions of audio enhancement engine 216. In some examples, audio enhancement engine 216 may be performed, at least in part, by special-purpose hardware.

Reference audio data 218 may representing the sounds of voices of one or more individuals, such as parents, friends, caregivers, or children of user 104. Identification ML model 212 may be trained to generate voice embeddings 220 based on reference audio data 218. Each of voice embeddings 220 is data that characterizes the voice of a particular individual or a type of voice. In other words, each of voice embeddings 220 may be associated with a voice of an individual or type of voice. Each of voice embeddings 220 may be referred to as a “voiceprint” because the voice embedding that characterizes the voice of an individual or type of individual may, analogously to fingerprints, include data that differentiates the voice from the voices of other individuals. Identification ML model 212 may only need to generate a single embedding for an individual for hearing instruments 102 to enhance audio associated with the individual. Identification ML model 212 may store the embedding in storage devices 202.

In some examples, processors 206 of hearing instrument 102A train identification ML model 212. In other examples, identification ML model 212 may be trained by processors of other devices. In some examples, identification ML model 212 may be trained by providing a data set that includes a representation of the live audio to identification ML model 212, apply a loss function to the output of identification ML model 212, and update the model parameters of identification ML model 212 based on the loss value. In addition, processors 206 may train identification ML model 212 using a generalized end-to-end loss function.

In other examples, identification ML model 212 and reference audio data 218 are not stored or used in hearing instruments, such as hearing instrument 102A. Instead, in such examples, hearing instrument 102 may receive voice embeddings 220 from another device or system, such as computing system 106.

Identification ML model 212 may be implemented in one of a variety of ways. For instance, identification ML model 212 may include a multi-layer long short-term memory neural network. In another example instance, identification ML model 212 may be implemented as a convolutional neural network (CNN). The CNN may include an input layer that takes, as input, a 2-dimensional spectrogram generated based on reference audio data for an individual or type of individual. The CNN may further include one or more convolutional layers. For instance, the CNN may include one, two, four, or another number of convolutional layers. Each of the convolutional layers may reduce the dimensionality of data provided as input to the convolutional layer. Activation functions, such as a Rectified Linear Unit (ReLU) activation function, a Leaky ReLU activation function, or a sigmoid activation function may be applied to the outputs of one or more of the convolutional layers. In some examples, identification ML model 212 may be implemented using the ML models described in Ye F, Yang J. A Deep Neural Network Model for Speaker Identification. Applied Sciences. 2021; 11(8):3603. https://doi.org/10.3390/app11083603, that includes a CNN and a Gated Recurrent Unit (GRU). In this model, one or more convolutional layers are followed by one or more GRUs, which are followed by one or more fully connected layers. A softmax layer may regularize outputs of the last fully connected layer.

In some examples, identification ML model 212 may be trained using a supervised learning process. In other examples, identification ML model 212 may be trained using an unsupervised learning process. In an example where identification ML model 212 is trained using a supervised learning process, identification ML model 212 may use a categorical cross-entropy loss function, or another type of loss function, to evaluate errors in output of identification ML model 212. Results of the loss function may be used in a backpropagation process to update parameters of identification ML model 212.

Furthermore, while user 104 is using hearing instrument 102A, microphones 116A may detect sound and generate audio data based on the detected sound. Audio enhancement engine 216 may use enhancement ML model 214 to generate enhanced audio data based on a voice embedding and based on live audio data generated by microphones 116A. The enhanced audio data may be enhanced such that portions of the live audio data corresponding to a voice or voices associated with the embedding are enhanced. For example, portions of the live audio data corresponding to a voice or voices associated with the voice embedding may have increased volume at specific frequencies. In some examples, the frequency of portions of the live audio data corresponding to the voice or voices associated with the voice embedding may be shifted to increase the comprehension of the voice or voices.

In some examples, audio enhancement engine 216 may perform a SFFT on the live audio data to generate a spectrogram. Audio enhancement engine 216 may use the spectrogram, along with a voice embedding, as input to enhancement ML model 214. In such examples, output of enhancement ML model 214 may include a masked spectrogram. Audio enhancement engine 216 may apply an inverse SFFT to the masked spectrogram to generate the enhanced audio data. Audio enhancement engine 216 may then cause receiver(s) 108A to generate audio output based on the enhanced audio data. In this way, audio enhancement engine 216 may cause receiver(s) 108A to output sound based on the masked spectrogram.

Enhancement ML model 214 may be implemented in one of a variety of ways. For example, enhancement ML model 214 include one or more layers of a convolutional neural network, a long short-term memory layer, and one or more fully connected (FC) layers. In some examples, an activation function for enhancement ML model 214 is a sigmoid activation function. In some examples, enhancement ML model 214 may be trained using a loss function to improve identification by enhancement ML model 214 of a voice from “noisy” audio that includes ambient noise. Such a loss function is provided in the equation below, with k being a term used to balance the calculation of the error of magnitude spectra and the calculation of the error of the complex spectra. In the below loss function, S_{clean}_{ₒ}^{0.3} represents the input signal containing a spectrograph of target audio (e.g., a voice to be enhanced) and S_{enhanced}^{0.3} represents the output of enhancement ML model 214 of a modified spectrogram of noisy audio with the target audio enhanced:

L=∥|S_{clean}_{ₒ}^{0.3}(t, f)|−|S_{enhanced}^{0.3}(t, f)|∥2/2+λ∥S_{clean}_{ₒ}^{0.3}(t, f)−S_{enhanced}^{0.3}(t, f)∥2/2

In some examples, storage devices 202 may include one or more group enhancement ML models 222. Audio enhancement engine 216 may use group enhancement ML models 222 to generate masked spectrograms representing audio data enhanced for voices of specific groups of people, such as children, worn en, men, etc. Input to group enhancement ML models 222 may include spectrograms based on live audio data, but does not necessarily include voice embeddings. Group enhancement ML models 222 may be implemented in one or more ways. For example, group enhancement ML models 222 may be implemented in a manner substantially similar to enhancement model 214.

In some examples, rather than enhancement ML model 214 and/or group enhancement ML models 222 directly generating masked spectrograms, enhancement ML model 214 and/or group enhancement ML models 222 may generate data that audio enhancement engine 216 convolves with (e.g., multiplies by) the input spectrogram to generate the masked spectrogram.

Group enhancement ML models 222 may include a third ML model to generate a second masked spectrogram based on a selection of a voice and an input spectrogram. Group enhancement ML models 222 may generate a second masked spectrogram that represents a second version of the live audio in which portions of the live audio data spoken in the type of voice selected by a user are enhanced. Group enhancement ML models 222 may generate the second masked spectrogram based on hearing instrument 102A receiving a selection of a type of voice from among one or more types of voices.

FIG. 3 is a block diagram illustrating example components of computing device 300, in accordance with one or more aspects of this disclosure. FIG. 3 illustrates only one particular example of computing device 300, and many other example configurations of computing device 300 exist. Computing device 300 may be a computing device in computing system 106 (FIG. 1).

As shown in the example of FIG. 3, computing device 300 includes one or more processors 302, one or more communication units 304, one or more input devices 308, one or more output device(s) 310, a display screen 312, a power source 314, one or more storage device(s) 316, and one or more communication channels 318. Computing device 300 may include other components. For example, computing device 300 may include physical buttons, microphones, speakers, communication ports, and so on. Communication channel(s) 318 may interconnect each of processors 302, communication units 304, input devices 308, output devices 310, display screen 312, and storage devices 316 for inter-component communications (physically, communicatively, and/or operatively). In some examples, communication channels 318 may include a system bus, a network connection, an inter-process communication data structure, or any other method for communicating data. Power source 314 may provide electrical energy to components processors 302, communication units 304, input devices 308, output devices 310, display screen 312, and storage devices 316.

Storage devices 316 may store information required for use during operation of computing device 300. In some examples, storage devices 316 have the primary purpose of being a short-term and not a long-term computer-readable storage medium. Storage devices 316 may include volatile memory and may therefore not retain stored contents if powered off. In some examples, storage devices 316 includes non-volatile memory that is configured for long-term storage of information and for retaining information after power on/off cycles. In some examples, processors 302 of computing device 300 may read and execute instructions stored by storage devices 316.

Computing device 300 may include one or more input devices 308 that computing device 300 uses to receive user input. Examples of user input include tactile, audio, and video user input. Input devices 308 may include presence-sensitive screens, touch-sensitive screens, mice, keyboards, voice responsive systems, microphones, motion sensors capable of detecting gestures, or other types of devices for detecting input from a human or machine.

Communication units 304 may enable computing device 300 to send data to and receive data from one or more other computing devices (e.g., via a communication network, such as a local area network or the Internet). For instance, communication units 304 may be configured to receive data sent by hearing instruments 102, receive data generated by user 104 of hearing instruments 102, receive and send data, receive and send messages, and so on. In some examples, communication units 304 may include wireless transmitters and receivers that enable computing device 300 to communicate wirelessly with the other computing devices. For instance, in the example of FIG. 3, communication units 304 include a radio 306 that enables computing device 300 to communicate wirelessly with other computing devices, such as hearing instruments 102 (FIG. 1). Examples of communication units 304 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc. Computing device 300 may use communication units 304 to communicate with one or more hearing instruments (e.g., hearing instruments 102 (FIG. 1, FIG. 2)). Additionally, computing device 300 may use communication units 304 to communicate with one or more other devices.

Output devices 310 may generate output. Examples of output include tactile, audio, and video output. Output devices 310 may include presence-sensitive screens, sound cards, video graphics adapter cards, speakers, liquid crystal displays (LCD), light emitting diode (LED) displays, or other types of devices for generating output. Output devices 310 may include display screen 312. In some examples, output devices 310 may include virtual reality, augmented reality, or mixed reality display devices.

Processors 302 may read instructions from storage devices 316 and may execute instructions stored by storage devices 316. Execution of the instructions by processors 302 may configure or cause computing device 300 to provide at least some of the functionality ascribed in this disclosure to computing device 300 or components thereof (e.g., processors 302). As shown in the example of FIG. 3, storage devices 316 include computer-readable instructions associated with operating system 320, application modules 322A-322N (collectively, “application modules 322”), and a companion application 324.

Execution of instructions associated with operating system 320 may cause computing device 300 to perform various functions to manage hardware resources of computing device 300 and to provide various common services for other computer programs. Execution of instructions associated with application modules 322 may cause computing device 300 to provide one or more of various applications (e.g., “apps,” operating system applications, etc.). Application modules 322 may provide applications, such as text messaging (e.g., SMS) applications, instant messaging applications, email applications, social media applications, text composition applications, and so on.

Companion application 324 is an application that may be used to interact with hearing instruments 102, view information about hearing instruments 102, or perform other activities related to hearing instruments 102. Execution of instructions associated with companion application 324 by processor(s) 302 may cause computing device 300 to perform one or more of various functions. For example, execution of instructions associated with companion application 324 may cause computing device 300 to configure communication unit(s) 304 to receive data from hearing instruments 102 and use the received data to present data to a user, such as user 104 or a third-party user. In some examples, companion application 324 is an instance of a web application or server application. In some examples, such as examples where computing device 300 is a mobile device or other type of computing device, companion application 324 may be a native application.

In some examples, companion application 324 includes an identification ML model 328. Identification ML model 328 may perform the same functions and may be implemented in the same way as identification ML model 212. Companion application 324 may receive reference audio data, e.g., from input devices 308, from hearing instruments 102, or another source. Companion application 324 may use identification ML model 328 to generate voice embeddings. Companion application 324 may then send the voice embeddings to hearing instruments 102. In some examples, companion application 324 may send to hearing instruments 102 information identifying individuals or groups of individuals whose voices correspond to the voice embeddings. Hearing instruments 102 may generate a masked spectrogram based on the voice embeddings generated at computing system 106 and live audio data detected by microphones 116 of hearing instruments 102. Hearing instruments 102 may output sound based on the masked spectrogram (e.g., sound corresponding to the enhanced audio of the masked spectrogram).

Companion application 324 may cause computing system 106 to generate a GUI and display the GUI via display screen 312. Companion application 324 may cause computing system 106 to generate a GUI that includes visual elements listing individuals for which computing system 106 and hearing instruments 102 have voiceprints.

Companion application 324 may receive a request from user 104 via input devices 308 to create a voiceprint for a particular individual. In other words, companion application 324 may obtain reference audio data and generate voice embeddings in response to indications of user input received by computing system 106. For example, companion application 324 may generate a GUI that includes features that enable a user to add a new voice embedding. In this example, the GUI may prompt an individual to provide a vocal sample, such as a few predefined sentences. For instance, companion application 324 may cause computing system 106 to record, via input device(s) 308, the particular individual speaking the phrase or series of words displayed on display screen 312 and store it as reference audio data. The GUI may also request input of information identifying the individual.

Companion application 324 may enable user 104 to select which voices user 104 would like to have enhanced. For instance, companion application 324 may cause display screen 312 to display a GUI that includes a list of individuals and/or groups of individuals for user 104 to select and have the respective voices enhanced. In an example, companion application 324 causes display screen 312 to display a GUI that includes visual elements that display names of individuals. Input device(s) 308 receive input consistent with user 104 selecting a plurality of the names and provide indication regarding the user input to companion application 324. Companion application 324, responsive to the receipt of the indication, causes communication unit(s) 304 to provide an instruction to hearing instruments 102 to enhance the audio associated with the individuals selected by user 104.

Companion application 324 may generate one or more user interfaces. Companion application 324 may generate an updated user interface in response to computing device 300 receiving input consistent with user interaction with a user interface. In an example, as part of receiving a selection of a voice companion, application 324 receives user input at a first user interface, where the first user interface includes visual elements displaying types of voices that can be selected to indicate which voices should be enhanced (e.g., children's voices, elderly voices, male/female voices, etc.). Companion application 324 determines, based on the user input, the type of voice to be enhanced. Companion application 324 generates a second user interface that includes visual indications of the selection of the type of voice and other information for reference by the user, and outputs, for display, the second user interface. Companion application 324 may generate a user interface that includes information about which voices and/or types of voices are currently selected for enhancement.

Companion application 324 may enable user 104 to create groups of individuals to have audio associated with the voices of the group enhanced. For example, companion application 324 may enable user 104 to create a group of their immediate family members, a group of specific friends, and other groups. In another example, companion application 324 may enable user 104 to select one or more types of voices for enhancement such as male voices, female voices, children's voices, elderly voice, and other classifications of voices.

In some examples, companion application 324 may automatically determine that certain voices and/or types of voices should be enhanced. Companion application 324 may utilize the location of computing system 106 to determine whether hearing instruments 102 should enhance voice audio. For example, companion application 324 may determine that user 104 is walking along a street in a major city and thus could benefit from the enhancing of voices due to the loud background noise of the street. In another example, companion application 324 determines, based on location data of computing system 106, that user 104 has entered a restaurant. Responsive to the determination of user 104's location, companion application 324, may instruct hearing instruments 102 to enhance the voices of one or more individuals or categories of individuals. In some examples, audio enhancement engine 216 may perform similar functionality to automatically determine that certain voices and/or types of voices should be enhanced.

Companion application 324 may cause display screen 312 to display visual GUI elements that indicate to the user to change the magnitude of the audio enhancement. For example, companion application 324 may cause display screen 312 to display visual GUI elements labeled as “Increase speech volume” and “Decrease speech volume”. Responsive to user input consistent with user 104 selecting “Increase speech volume”, companion application 324 causes communication unit(s) 304 to provide an instruction to hearing instruments 102 to increase the volume of voices of particular individuals.

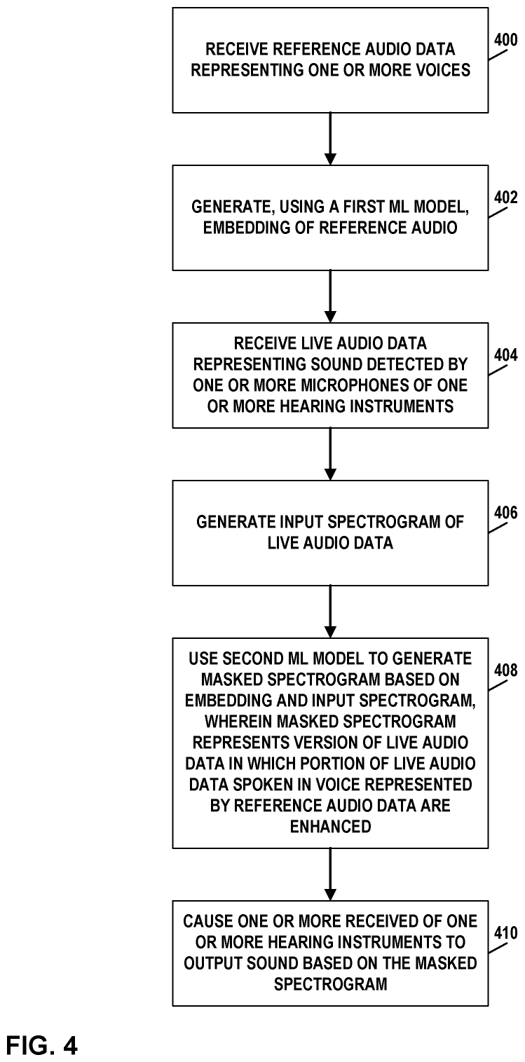

FIG. 4 is a flowchart illustrating an example operation in accordance with one or more techniques of this disclosure. Other examples of this disclosure may include more, fewer, or different actions. In some examples, actions in the flowcharts of this disclosure may be performed in parallel or in different orders.

In the example of FIG. 4, a processing system such as processing system 114 illustrated in FIG. 1 receives reference audio data that represents one or more voices (400). Processing system 114 may receive reference audio data via one or more components, such as microphones 116 of hearing instruments 102, an input device of computing system 106. Processing system 114 may receive reference audio data following a request for one or more individuals to speak a selected phrase or series of words.

Processing system 114 generates, using a first machine learning (ML) model, an embedding of the reference audio data (402). Processing system 114 may utilize a deep neural network trained to identify the signature of a voice to generate an embedding that comprises data indicative of the signature of one or more individuals' voices.

Processing system 114 receives audio data representing sound detected by one or more microphones of the one or more hearing instruments such as hearing instruments 102 as illustrated by FIG. 1 (404). Processing system 114 may receive audio data from one or more components of hearing instruments 102 such as microphone(s) 116.

Processing system 114 generates an input spectrogram of the live audio data (406). Processing system 114 may generate the input spectrogram using a sparse fast Fourier transform (SFFT).

Processing system 114 uses a second ML model to generate a masked spectrogram based on the embedding and the input spectrogram, wherein the masked spectrogram represents a version of the live audio data in which portions of the live audio data spoken in the voices represented by the reference audio data are enhanced (408). Processing system 114 may utilize a deep neural network trained to identify voices within audio data and the embedding generated by the first ML model to generate the masked spectrogram. Processing system 114 may utilize the deep neural network to identify voices associated with the reference audio data from audio live audio represented by the input spectrogram. Processing system 114 may generate a version of the live audio in which the audio spoken by the one or more voices is enhanced in one or more ways such as increasing the volume of the audio spoken by the one or more voices, shifting the frequencies of the audio associated with the one or more voices to a lower band of frequencies, and other ways of audio enhancement.

Processing system 114 causes one or more receivers of one or more of hearing instruments to output sound based on the masked spectrogram (410). For example, processing system 114 may convert the masked spectrogram to enhanced audio data. The enhanced audio data may represent the enhanced audio as a digital waveform format. Receivers 108 or processing system 114 may further convert the enhanced audio data to an analog electrical signal that receivers 108 use to output the sound.

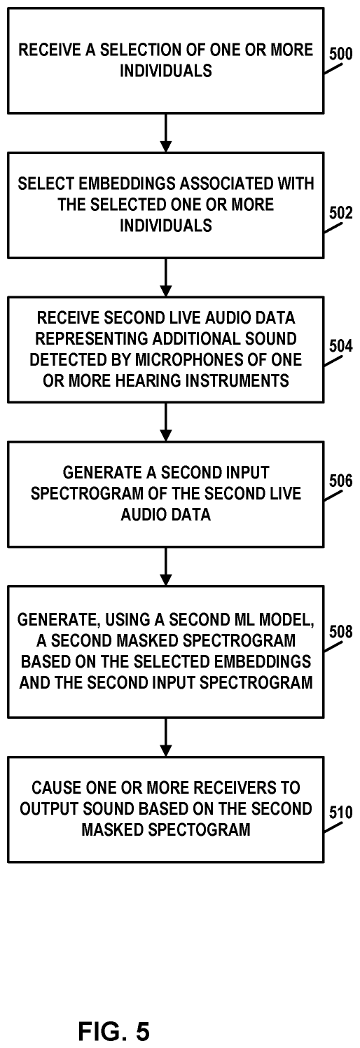

FIG. 5 is a flowchart illustrating an example operation in accordance with one or more techniques described in this disclosure. In the example of FIG. 5, a processing system, such as processing system 114 illustrated in FIG. 1, receives a selection of one or more individuals (500). Processing system 114 may receive data regarding the selection from a computing system such as computing system 106, or may receive the selection of one or more individuals via one or more components such as sensors 110A.

Processing system 114 selects embeddings associated with the selected one or more individuals (502). Processing system 114 may select the embeddings from a plurality of embeddings maintained by processing system 114. Processing system 114 may organize the embeddings based on associations with particular individuals (e.g., a first embedding is associated with a first individual, a second embedding is associated with a second individual, etc.).

Processing system 114 receives second live audio data representing additional sound detected by one or more microphones, such as microphones 116, of one or more hearing instruments, such as hearing instruments 102 (504). Processing system 114 may receive the second live audio data that is live audio data of an environment of a hearing instruments 102. For example, processing system 114 may receive second live audio data that is audio data of conversations in a restaurant.

Processing system 114 generates a second input spectrogram of the second live audio data (506). Processing system 114 may generate an input spectrogram that is representative of the additional sound detected by microphones 116. In some examples, processing system 114 may use an SFFT to generate the second input spectrogram.

Processing system 114 generates, using a second ML model, such as enhancement ML model 214, a second masked spectrogram based on the selected embeddings and the second input spectrogram (508). Processing system 114 may generate the second masked spectrogram by providing the selected embeddings and the input spectrogram of the live audio to enhancement ML model 214 for enhancement ML model 214 to generate the second masked spectrogram. In this way, processing system 114 may generates, using the second ML model, enhanced audio of the live audio in which the audio of the one or more persons corresponding to the one or more voiceprints (i.e., embeddings associated with the selected individuals) is enhanced.

Processing system 114 causes receivers, such as receivers 108, to output sound based on the second masked spectrogram (510). Processing system 114 may cause receivers 108 to output sound that includes one or more enhancements to the second live audio. For example, processing system 114 may cause receivers 108 to output sound that includes sound of the voices associated with the selected one or more individuals increased in volume relative to other sound.

Example 1: A method includes receiving, by a processing system, reference audio data representing one or more voices; generating, by the processing system and using a first machine learning (ML) model, an embedding of the reference audio data; receiving, by the processing system, live audio data representing sound detected by one or more microphones of one or more hearing instruments; generating, by the processing system, an input spectrogram of the live audio data; using, by the processing system, a second ML model to generate a masked spectrogram based on the embedding and the input spectrogram, wherein the masked spectrogram represents a version of the live audio data in which portions of the live audio data spoken in the voices represented by the reference audio data are enhanced; and causing, by the processing system, one or more receivers of the one or more hearing instruments to output sound based on the masked spectrogram.

Example 2: The method of example 1, wherein the first ML model is a first neural network and the second ML model is a second neural network.

Example 3: The method of any of examples 1 and 2 includes providing, by the processing system, a first request to a computing device for a first individual to provide first input consistent with speaking a predetermined word or phrase; obtaining, by the processing system, the reference audio data as the first input; and associating, by the processing system, the reference audio data with the first individual.

Example 4: The method of example 3, wherein the reference audio data is first reference audio data, and the method comprises: providing, by the processing system, a second request to the computing device for a second individual to provide second input consistent with speaking the predetermined word or phrase; obtaining, by the processing system, second reference audio data as the second input; and associating, by the processing system, the second reference audio data with the second individual.

Example 5: The method of any of examples 1 through 4, comprising receiving, by the processing system, user input of a request to set the hearing instrument into a group mode, wherein, when the hearing instrument is in the group mode, the processing system uses the second ML model to generate a masked spectrogram where one or more voices selected by a user are enhanced.

Example 6: The method of any of examples 1 through 5, wherein the masked spectrogram is a first masked spectrogram, and the method further comprises: receiving, by the processing system, a selection of one or more individuals; selecting, by the processing system, embeddings associated with the selected one or more individuals; receiving, by the processing system, second live audio data representing additional sound detected by the one or more microphones of the one or more hearing instruments; generating, by the processing system, a second input spectrogram of the second live audio data; generating, using the second ML model, a second masked spectrogram based on the selected embeddings and the second input spectrogram; and causing, by the processing system, the one or more receivers to output sound based on the second masked spectrogram.

Example 7: The method of any of examples 1 through 6, wherein the masked spectrogram is a first masked spectrogram and the method further comprises: receiving, by the processing system, from a user, a selection of a type of voice from among one or more types of voices; receiving, by the processing system, second live audio data representing additional sound detected by the one or more microphones of the one or more hearing instruments; using, by the processing system, a second input spectrogram of the second live audio data; using, by the processing system, a third ML model to generate a second masked spectrogram based on the selection of the type of voice and the second input spectrogram, wherein the second masked spectrogram represents a version of the second live audio data in which portions of the second live audio data spoken in the selected type of voice are enhanced; and causing, by the processing system, the one or more receivers of the hearing instruments to output sound based on the second masked spectrogram.

Example 8: The method of example 7, wherein the type of voice is one of: male voices; female voices; child voices; elderly voices; or user-defined selections of voices.

Example 9: The method of any of examples 7 and 8, wherein: receiving the selection of the type of voice further comprises receiving user input at a first user interface, and the method further comprises: determining, by the processing system, the selected type of voice based on the user input; generating, by the processing system, a second user interface that includes an indication of the selection of the type of voice; and outputting, by the processing system and for display, the second user interface.

Example 10: The method of any of examples 1 through 9, further includes determining, by the processing system, that the one or more hearing instruments are located in a particular location; and selecting, by the processing system, based on the one or more hearing instruments being located in the particular location, the embedding from among a plurality of stored embeddings.

Example 11: A hearing instrument includes one or more microphones; and one or more programmable processors, configured to: receive reference audio data representing one or more voices; generate, using a first machine learning (ML) model, an embedding of the reference audio data; receive live audio data representing sound detected by the one or more microphones; generate an input spectrogram of the live audio data; use a second ML model to generate a masked spectrogram based on the embedding and the input spectrogram, wherein the masked spectrogram represents a version of the live audio data in which portions of the live audio data spoken in the voices represented by the reference audio data are enhanced; and cause one or more receivers of the one or more hearing instruments to output sound based on the masked spectrogram.

Example 12: The hearing instrument of example 11, wherein the first ML model is a first neural network and the second ML model is a second neural network.

Example 13: The hearing instrument of any of examples 11 and 12, wherein the one or more programmable processors are configured to: provide a first request to a computing device for a first individual to provide first input consistent with speaking a predetermined word or phrase; obtain the reference audio data as the first input; and associate the reference audio data with the first individual.

Example 14: The hearing instrument of example 13, wherein the reference audio data is first reference audio data, and the one or more programmable processors are configured to: provide a second request to the computing device for a second individual to provide second input consistent with speaking the predetermined word or phrase; obtain second reference audio data as the second input; and associate the second reference audio data with the second individual.

Example 15: The hearing instrument of any of examples 11 through 14, wherein the one or more programmable processors are configured to receive user input of a request to set the hearing instrument into a group mode, wherein when in the group mode the one or more programmable processors use the second ML model to generate a masked spectrogram where one or more voices selected by a user are enhanced.

Example 16: The hearing instrument of any of examples 11 through 15, wherein the one or more programmable processors are configured to: receive a selection of one or more individuals; select embeddings associated with the selected one or more individuals; receive second live audio data representing additional sound detected by the one or more microphones of the one or more hearing instruments; generate a second input spectrogram of the second live audio data; generate, using the second ML mode, a second masked spectrogram based on the selected embeddings and the second input spectrogram; and cause the one or more receives to output sound based on the second masked spectrogram.

Example 17: The hearing instrument of any of examples 11 through 16, wherein the masked spectrogram is a first masked spectrogram and wherein the one or more programmable processors are configured to receive, from a user a selection of a type of voice from among one or more types of voices; receive second live audio data representing additional sound detected by the one or more microphones of the one or more hearing instruments; generate a second input spectrogram of the second live audio data; use a third ML model to generate a second masked spectrogram based on the selection of the type of voice and the second input spectrogram, wherein the second masked spectrogram represents a version of the second live audio data in which portions of the second live audio data spoken in the type of voice selected by a user are enhanced; and cause the one or more receivers to output sound based on the second masked spectrogram.

Example 18: The hearing instrument of any of examples 11 through 17, wherein the one or more programmable processors are configured to, prior to using the second ML model to generate the masked spectrogram based on the embedding and the input spectrogram: determine that the hearing instrument is located in a particular location; and select, based on the embedding being associated with the particular location, the embedding from among a plurality of stored embedding.

Example 19: On or more non-transitory computer-readable media comprising instructions stored thereon that, when executed by one or more processors, cause the one or more processors to: receive reference audio data representing one or more voices; generate, using a first machine learning (ML) model, an embedding of the reference audio data; receive live audio data representing sound detected by one or more microphones of one or more hearing instruments; generate an input spectrogram of the live audio data; and use a second ML model to generate a masked spectrogram based on the embedding and the input spectrogram, wherein the masked spectrogram represents a version of the live audio data in which portions of the live audio data spoken in the voices represented by the reference audio data are enhanced; and cause one or more receivers of the one or more hearing instruments to output sound based on the masked spectrogram.

Example 20: The one or more non-transitory computer-readable media of example 19, wherein the first ML model is a first neural network and the second ML model is a second neural network.

In this disclosure, ordinal terms such as “first,” “second,” “third,” and so on, are not necessarily indicators of positions within an order, but rather may be used to distinguish different instances of the same thing. Examples provided in this disclosure may be used together, separately, or in various combinations. Furthermore, with respect to examples that involve personal data regarding a user, it may be required that such personal data only be used with the permission of the user.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processing circuits to retrieve instructions, code and/or data structures for implementation of the techniques described in this disclosure. A computer program product may include a computer-readable medium.

By way of example, and not limitation, such computer-readable storage media may include RAM, ROM, EEPROM, CD-ROM or other optical disk storage, magnetic disk storage, or other magnetic storage devices, flash memory, cache memory, or any other medium that can be used to store desired program code in the form of instructions or store data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Functionality described in this disclosure may be performed by fixed function and/or programmable processing circuitry. For instance, instructions may be executed by fixed function and/or programmable processing circuitry. Such processing circuitry may include one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements. Processing circuits may be coupled to other components in various ways. For example, a processing circuit may be coupled to other components via an internal device interconnect, a wired or wireless network connection, or another communication medium.

The techniques of this disclosure may be implemented in a wide variety of devices or apparatuses, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method, comprising:
receiving, by a processing system, reference audio data representing one or more voices;
generating, by the processing system and using a first machine learning (ML) model, an embedding of the reference audio data;
receiving, by the processing system, live audio data representing sound detected by one or more microphones of one or more hearing instruments;
generating, by the processing system, an input spectrogram of the live audio data;
using, by the processing system, a second ML model to generate a masked spectrogram based on the embedding and the input spectrogram, wherein the masked spectrogram represents a version of the live audio data in which portions of the live audio data spoken in the voices represented by the reference audio data are enhanced; and
causing, by the processing system, one or more receivers of the one or more hearing instruments to output sound based on the masked spectrogram.

2. The method of claim 1, wherein the first ML model is a first neural network and the second ML model is a second neural network.

3. The method of claim 1, comprising:
providing, by the processing system, a first request to a computing device for a first individual to provide first input consistent with speaking a predetermined word or phrase;
obtaining, by the processing system, the reference audio data as the first input; and
associating, by the processing system, the reference audio data with the first individual.

4. The method of claim 3, wherein the reference audio data is first reference audio data, and the method comprises:
providing, by the processing system, a second request to the computing device for a second individual to provide second input consistent with speaking the predetermined word or phrase;
obtaining, by the processing system, second reference audio data as the second input; and
associating, by the processing system, the second reference audio data with the second individual.

5. The method of claim 1, comprising receiving, by the processing system, user input of a request to set the hearing instrument into a group mode,
wherein, when the hearing instrument is in the group mode, the processing system uses the second ML model to generate a masked spectrogram where one or more voices selected by a user are enhanced.

6. The method of claim 1, wherein the masked spectrogram is a first masked spectrogram, and the method further comprises:
receiving, by the processing system, a selection of one or more individuals;
selecting, by the processing system, embeddings associated with the selected one or more individuals;
receiving, by the processing system, second live audio data representing additional sound detected by the one or more microphones of the one or more hearing instruments;
generating, by the processing system, a second input spectrogram of the second live audio data;
generating, using the second ML model, a second masked spectrogram based on the selected embeddings and the second input spectrogram; and
causing, by the processing system, the one or more receivers to output sound based on the second masked spectrogram.

7. The method of claim 1, wherein the masked spectrogram is a first masked spectrogram, and the method further comprises:
receiving, by the processing system, from a user, a selection of a type of voice from among one or more types of voices;
receiving, by the processing system, second live audio data representing additional sound detected by the one or more microphones of the one or more hearing instruments;
generating, by the processing system, a second input spectrogram of the second live audio data;
using, by the processing system, a third ML model to generate a second masked spectrogram based on the selection of the type of voice and the second input spectrogram, wherein the second masked spectrogram represents a version of the second live audio data in which portions of the second live audio data spoken in the selected type of voice are enhanced; and
causing, by the processing system, the one or more receivers to output sound based on the second masked spectrogram.

8. The method of claim 7, wherein the type of voice is one of:
male voices;
female voices;
child voices;
elderly voices; or
user-defined selections of voices.

9. The method of claim 7, wherein:
receiving the selection of the type of voice further comprises receiving user input at a first user interface, and
the method further comprises:
determining, by the processing system, the selected type of voice based on the user input;
generating, by the processing system, a second user interface that includes an indication of the selection of the type of voice; and
outputting, by the processing system and for display, the second user interface.

10. The method of claim 1, further comprising, prior to using the second ML model to generate the masked spectrogram:
determining, by the processing system, that the one or more hearing instruments are located in a particular location; and
selecting, by the processing system, based on the one or more hearing instruments being located in the particular location, the embedding from among a plurality of stored embeddings.

11. A hearing instrument comprising:
one or more microphones; and
one or more programmable processors, configured to:
receive reference audio data representing one or more voices;
generate, using a first machine learning (ML) model, an embedding of the reference audio data;
receive live audio data representing sound detected by the one or more microphones;
generate an input spectrogram of the live audio data;
use a second ML model to generate a masked spectrogram based on the embedding and the input spectrogram, wherein the masked spectrogram represents a version of the live audio data in which portions of the live audio data spoken in the voices represented by the reference audio data are enhanced; and
cause one or more receivers of the one or more hearing instruments to output sound based on the masked spectrogram.

12. The hearing instrument of claim 11, wherein the first ML model is a first neural network and the second ML model is a second neural network.

13. The hearing instrument of claim 11, wherein the one or more programmable processors are configured to:
provide a first request to a computing device for a first individual to provide first input consistent with speaking a predetermined word or phrase;
obtain the reference audio data as the first input; and
associate the reference audio data with the first individual.

14. The hearing instrument of claim 13, wherein the reference audio data is first reference audio data, and the one or more programmable processors are configured to:
provide a second request to the computing device for a second individual to provide second input consistent with speaking the predetermined word or phrase;
obtain second reference audio data as the second input; and
associate the second reference audio data with the second individual.

15. The hearing instrument of claim 11, wherein the one or more programmable processors are configured to receive user input of a request to set the hearing instrument into a group mode, wherein when in the group mode the one or more programmable processors use the second ML model to generate a masked spectrogram where one or more voices selected by a user are enhanced.

16. The hearing instrument of claim 11, wherein the one or more programmable processors are configured to:
receive a selection of one or more individuals;
select embeddings associated with the selected one or more individuals;
receive second live audio data representing additional sound detected by the one or more microphones of the one or more hearing instruments;
generate a second input spectrogram of the second live audio data;
generate, using the second ML mode, a second masked spectrogram based on the selected embeddings and the second input spectrogram; and
cause the one or more receives to output sound based on the second masked spectrogram.

17. The hearing instrument of claim 11, wherein the masked spectrogram is a first masked spectrogram and wherein the one or more programmable processors are configured to:
receive, from a user a selection of a type of voice from among one or more types of voices;
receive second live audio data representing additional sound detected by the one or more microphones of the one or more hearing instruments;
generate a second input spectrogram of the second live audio data;
use a third ML model to generate a second masked spectrogram based on the selection of the type of voice and the second input spectrogram, wherein the second masked spectrogram represents a version of the second live audio data in which portions of the second live audio data spoken in the type of voice selected by a user are enhanced; and
cause the one or more receivers to output sound based on the second masked spectrogram.

18. The hearing instrument of claim 11, wherein the one or more programmable processors are configured to, prior to using the second ML model to generate the masked spectrogram based on the embedding and the input spectrogram:
determine that the hearing instrument is located in a particular location; and
select, based on the embedding being associated with the particular location, the embedding from among a plurality of stored embeddings.

19. One or more non-transitory computer-readable media comprising instructions stored thereon that, when executed by one or more processors, configured to cause the one or more processors to:
receive reference audio data representing one or more voices;
generate, using a first machine learning (ML) model, an embedding of the reference audio data;
receive live audio data representing sound detected by one or more microphones of one or more hearing instruments;
generate an input spectrogram of the live audio data; and
use a second ML model to generate a masked spectrogram based on the embedding and the input spectrogram, wherein the masked spectrogram represents a version of the live audio data in which portions of the live audio data spoken in the voices represented by the reference audio data are enhanced; and
cause one or more receivers of the one or more hearing instruments to output sound based on the masked spectrogram.

20. The one or more non-transitory computer-readable media of claim 19, wherein the first ML model is a first neural network and the second ML model is a second neural network.
